(19) United States
(12) Patent Application Publication
(10) Pub. No.: US 2023/0261578 A1
(43) Pub. Date: Aug. 17, 2023

(54) POWER CONVERSION CIRCUIT AND CONTROL SYSTEM

(71) Applicant: FLOSFIA INC., Kyoto (JP)

(72) Inventors: Toshihiro IWAKI, Tokyo (JP); Takuto IGAWA, Kyoto (JP); Hidehito KITAKADO, Kyoto (JP); Yusuke MATSUBARA, Kyoto (JP)

(21) Appl. No.: 18/128,512

(22) Filed: Mar. 30, 2023

Related U.S. Application Data
(63) Continuation-in-part of application No. PCT/JP2021/035606, filed on Sep. 28, 2021.

(30) Foreign Application Priority Data
Sep. 30, 2020 (JP) 2020-166482

(51) Int. Cl. H02M 3/158; H02M 1/14

(52) U.S. Cl. CPC H02M 3/1582; H02M 1/143

(57) ABSTRACT

Provided is a power conversion circuit and a control system in which radiated noise of the entire circuit is reduced. A power conversion circuit including at least: a switching element (e.g. a MOSFET, etc.) and a diode (e.g. a commutating diode, etc.): wherein the power conversion circuit is a single-switch power conversion; and the diode is a gallium oxide-based Schottky barrier diode.

### CROSS REFERENCE TO RELATED APPLICATION

This application is a continuation-in-part application of International Patent Application No. PCT/JP2021/035606 (Filed on Sep. 28, 2021), which claims the benefit of priority from Japanese Patent Applications No. 2020-166482 (filed on Sep. 30, 2020).

The entire contents of the above applications, which the present application is based on, are incorporated herein by reference.

### 1. FIELD OF THE INVENTION

The present disclosure relates to a power conversion circuit and a power control system.

### 2. DESCRIPTION OF THE RELATED ART

As next-generation switching elements capable of obtaining high-voltage, low loss and high heat resistance, semiconductor devices configured using gallium oxide (Ga₂O₃) with a large band gap have received much attention. Such semiconductor devices are expected to be applied to power semiconductor devices for inverters and converters or the like. Furthermore, such semiconductor devices with large band gaps are expected to be applied as light emitters and light receivers for LEDs and sensors or the like. The above-mentioned gallium oxide is allowed to be subjected to band gap control by mixing crystals with indium, aluminum, or a combination thereof, thereby configuring a quite attractive family of materials as an InAlGaO-based semiconductor. Here, InAlGaO-based semiconductors indicates In_{X}Al_{Y}Ga_{Z}O₃ (0≤X≤2, 0≤Y≤2, 0≤Z≤2, X+Y+Z=1.5 to 2.5) and may be regarded as a family of materials including gallium oxide.

It is known that a Schottky diode containing a β-Ga₂O₃-based semiconductor is used as a freewheeling diode of a switching circuit including a Schottky diode and a transistor.

Moreover, it is known that a wide bandgap semiconductor element (any one of silicon carbide, gallium nitride, gallium oxide, and diamond or a combination thereof) is used for some or all of diodes or switching elements in the switching unit of an ac-to-dc conversion.

### SUMMARY OF THE INVENTION

According to an example of the present disclosure, there is provided a power conversion circuit including at least: a switching element; and a diode, wherein the power conversion circuit is a single-switch power conversion; and the diode is a gallium oxide-based Schottky barrier diode.

According to an example of the present disclosure, there is provided a control system including the power conversion circuit.

Thus, a power conversion circuit and a power control system of the present disclosure enables reducing radiated noise over the circuit.

### BRIEF DESCRIPTION OF THE DRAWINGS

FIG. 1 is a circuit diagram schematically illustrating a power conversion system according to a first embodiment of the present disclosure.

FIG. 2 is a circuit diagram schematically illustrating a power conversion system according to a second embodiment of the present disclosure.

FIG. 3 is a circuit diagram schematically illustrating a power conversion system according to a third embodiment of the present disclosure.

FIG. 4 schematically illustrates a preferred example of a Schottky barrier diode according to the embodiments of the present disclosure.

FIG. 5 shows PFC operation waveforms in an example and a comparative example.

FIG. 6 shows a diode turn-off waveform in the example.

FIG. 7 shows a diode turn-off waveform in the comparative example.

FIG. 8 shows a diode turn-off waveform in a comparative example.

FIG. 9 is a block diagram illustrating an example of a control system applying the semiconductor device according to an embodiment of the disclosure.

FIG. 10 is a block configuration diagram illustrating an example of the control system applying the semiconductor device according to an embodiment of the disclosure.

FIG. 11 schematically illustrates a preferred example of a Schottky barrier diode according to the embodiments of the present disclosure.

FIG. 12 is a circuit diagram schematically illustrating a power conversion system according to a fourth embodiment of the present disclosure.

FIG. 13 is a circuit diagram schematically illustrating a power conversion system according to a fifth embodiment of the present disclosure.

FIG. 14 is a circuit diagram schematically illustrating two or more power conversion circuits connected in parallel to form an interleave system.

### DETAILED DESCRIPTION

The inventors of the present disclosure found a power conversion circuit including at least, a switching element and a diode, wherein the power conversion circuit is a single-switch power conversion, and the diode is a gallium oxide-based Schottky barrier diode. The inventors have found that such power conversion circuit contributes to reducing a loss of the switching elements used together in the circuit. Furthermore, the inventors found that even if the switching element is controlled by a hard switching method, not only a noise caused by the diode but also radiated noise of the entire circuit is reduced, and both switching loss and radiated noise are reduced, and found that such a power conversion circuit may solve the above-described conventional problems at once.

Embodiments of the present disclosure will be described below with reference to the accompanying drawings. In the following description, the same parts and components are designated by the same reference numerals. The present embodiment includes, for example, the following disclosures.

### [Structure 1]

A power conversion circuit including at least: a switching element and a diode, wherein the power conversion circuit is a single-switch power conversion, and the diode is a gallium oxide-based Schottky barrier diode.

### [Structure 2]

The power conversion circuit according to [Structure 1], wherein the switching element is switch-controlled by a hard switching method.

### [Structure 3]

The power conversion circuit according to [Structure 2], wherein the power conversion circuit further includes a reactor, and the switching element opens and closes the inputted voltage via the reactor.

### [Structure 4]

The power conversion circuit according to [Structure 3], wherein the diode is a commutation diode that passes current in a direction of an electromotive force by a voltage including at least the electromotive force generated from the reactor.

### [Structure 5]

The power conversion circuit according to claim [Structure 3] or [Structure 4], wherein the reactor is disposed on an input side than the diode.

### [Structure 6]

The power conversion circuit according to [Structure 4] or [Structure 5], wherein the power conversion circuit further includes an output capacitor; the power conversion circuit is configured to supply the current to the output capacitor.

### [Structure 7]

The power conversion circuit according to any one of [Structure 1] to [Structure 6], wherein the switching element includes a gallium oxide-based MOSFET, a gallium oxide-based IGBT, a gallium nitride-based HEMT, a SiC-based MOSFET, or a SiC-based IGBT.

### [Structure 8]

The power conversion circuit according to any one of [Structure 1] to [Structure 7], wherein different semiconductors are used for the switching element and the diode.

### [Structure 9]

The power conversion circuit according to any one of [Structure 1] to[Structure 8], wherein the semiconductor used for the gallium oxide-based Schottky barrier diode has a larger band gap than a band gap of the semiconductor used for the switching element.

### [Structure 10]

The power conversion circuit according to any one of [Structure 1] to [Structure 9], wherein the gallium oxide-based Schottky barrier diode includes at least an n− type semiconductor layer having a carrier concentration of 2.0×10¹⁷/cm³ or less.

### [Structure 11]

The power conversion circuit according to [Structure 10], wherein the n− type semiconductor layer has a thickness of 1 μm to 10 μm.

### [Structure 12]

The power conversion circuit according to any one of [Structure 1] to [Structure 11], wherein the power conversion circuit is dc-to-dc conversion circuit.

### [Structure 13]

The power conversion circuit according to any one of [Structure 1] to [Structure 12], wherein the power conversion circuit is a step-up conversion circuit.

### [Structure 14]

A control system including a power conversion circuit: wherein the power conversion circuit is the power conversion according to any one of [Structure 1] to [Structure 13].

A power conversion circuit according to the present disclosure is characterized by including at least a switching element and a diode, wherein the power conversion circuit is a single-switch power conversion, and the diode is a gallium oxide-based Schottky barrier diode. The power conversion circuit is not particularly limited as long as it is a single-switch circuit using one switching element, and may be, for example, a single-switch inverter circuit or a single-switch converter circuit. In the power conversion circuit according to the embodiment of the present disclosure, a gallium oxide-based Schottky barrier diode is used as the diode. Thus, even with a simple circuit configuration such as a single-switch circuit, the switching loss and/or radiated noise of the entire circuit may be reduced. In an embodiment of the present disclosure, the power conversion circuit preferably further includes a reactor, and the switching element preferably opens and closes an inputted voltage via the reactor. The diode may be a freewheeling diode connected in anti-parallel to the switching element or a commutating diode, but are preferably commutating diodes in embodiments of the present disclosure. The commutation diode includes, for example, a commutating diode passing a current in the direction of an electromotive force by a voltage including at least the electromotive force generated from the reactor in an off period of the switching element.

In an embodiment of the present disclosure, it is preferable that the reactor is disposed on an input side than the diode. It is also preferred in embodiments of the present disclosure that the power conversion circuit further include a capacitor and is configured to supply a current flowing in the direction of the electromotive force to the capacitor via the commutating diode by a voltage including at least the electromotive force generated from the reactor. Further, the type of the power conversion circuit is not particularly limited as long as it does not hinder the purpose of the present disclosure, but in the embodiment of the present disclosure, it is preferably a dc-to-dc (DC-DC) conversion circuit, preferably a converter circuit, is more preferably a step-up conversion circuit. Circuit systems of the dc-to-dc conversion circuit include, for example, a single-ended forward system, a single-ended flyback system, a step-down chopper system, a step-up chopper system, and the like.

The switching element is not particularly limited unless it interferes with the present disclosure. The switching element may be a MOSFET or an IGBT. Examples of the switching element include a gallium oxide MOSFET, a gallium oxide-based IGBT, a gallium nitride-based HEMT, a SiC-based MOSFET or SiC-based IGBT, and a Si-based MOSFET or Si-based IGBT. In the embodiment of the present disclosure, the switching element is preferably a gallium oxide-based MOSFET, a gallium oxide-based IGBT, a gallium nitride-based HEMT, a SiC-based MOSFET, or a SiC-based IGBT. In the embodiment of the present disclosure, a gallium oxide-based Schottky barrier diode is used as the diode. This makes it possible to reduce further a loss of the switching elements used together in a circuit. In the embodiment of the present disclosure, the switching element preferably includes a freewheeling diode. The freewheeling diode may be integrated in the switching element or disposed outside the switching element.

The commutating diode is not particularly limited unless it interferes with the present disclosure. The commutating diode include, for example, a commutating diode passing a current in the direction of an electromotive force by a voltage including at least the electromotive force generated from the reactor in an off period of the switching element by energization in an on period of the switching element. In the embodiment of the present disclosure, it is preferable that the power conversion circuit further includes an output capacitor and is configured to supply the current to the output capacitor. In the embodiment of the present disclosure, the commutating diode is preferably disposed so as to prevent charge accumulated in the output capacitor from flowing backward. This is because a more proper measure is implementable against noise. If a gallium-oxide-based semiconductor is used, the gallium oxide-based Schottky barrier diode is not particularly limited unless it interferes with the present disclosure. Examples of the gallium-oxide-based semiconductor include semiconductors containing gallium oxide or a mixed crystal of gallium oxide. Furthermore, in the embodiment of the present disclosure, the gallium oxide-based Schottky barrier diode is preferably a junction-barrier Schottky diode (JBS). The crystal structure of the gallium-oxide semiconductor is also not particularly limited unless it interferes with the present disclosure. Examples of the crystal structure of the gallium-oxide semiconductor include a corundum structure, a β-gallia structure, a hexagonal structure (e.g., a ε-type structure), an orthorhombic structure (e.g., a κ-type structure), a cubic structure, and a tetragonal structure. In the embodiment of the present disclosure, the crystal structure of the gallium oxide semiconductor is preferably a corundum structure because the power conversion circuit is obtainable with better switching characteristics.

In the embodiment of the present disclosure, the gallium oxide-based Schottky barrier diode preferably includes at least an n− type semiconductor layer having a carrier concentration of 2.0×10¹⁷/cm³ or less because the effect of reducing radiated noise is more properly obtainable while reducing generated heat over the circuit. The carrier concentration of the n− type semiconductor layer is preferably within the range of 1.0×10¹⁶/cm³ to 5.0×10¹⁶/cm³. The thickness of the n− type semiconductor layer is not particularly limited but is preferably 1 μm to 10 μm, more preferably 2 μm to 5 μm. The carrier concentration and the thickness of the n− type semiconductor layer are set in the above preferable ranges, thereby improving the switching characteristics while securing heat dissipation. In the embodiment of the present disclosure, the gallium oxide-based Schottky barrier diode preferably further includes an n+ type semiconductor layer. The carrier concentration of the n+ type semiconductor layer is not particularly limited but is typically within the range of 1×10¹⁸/cm³ to 1×10²¹/cm³. Furthermore, the thickness of the n+ type semiconductor layer is not particularly limited but is preferably 0.1 μm to 30 μm, more preferably 0.1 μm to 10 μm, and most preferably 0.1 μm to 4 μm in the embodiment of the present disclosure. The n+ type semiconductor layer having the preferable thickness obtains a lower thermal resistance while keeping the switching characteristics.

In the embodiment of the present disclosure, different semiconductors are preferably used for the switching element and the diode. It is more preferable that the semiconductor used for the gallium oxide-based Schottky barrier diode has a larger band gap than a band gap of the semiconductor used for the switching element. Such a preferable configuration improves performance of the switching element even if a semiconductor having a smaller band gap than a band gap of the gallium oxide-based Schottky barrier diode is used for the switching element.

The switching frequency of the power conversion circuit is not particularly limited. The switching frequency is typically, for example, 50 kHz or higher. In the embodiment of the present disclosure, the switching frequency of the power conversion circuit is preferably 100 kHz or higher, more preferably 300 kHz or higher, and most preferably 500 kHz or higher in the embodiment of the present disclosure. The gallium oxide-based Schottky barrier diode is used as the diode, thereby achieving the power conversion circuit with reduced radiated noise even the switching frequency is at such a high switching frequency. A method of controlling the switching element may be a hard switching method or a soft switching method. In the present disclosure, the switching element is preferably switch-controlled by a hard switching method, and more preferably switch-controlled only by a hard switching method. In the embodiment of the present disclosure, a gallium oxide-based Schottky barrier diode is used as the diode. Thus, even if the switching element is controlled by a hard switching method, noise in the power conversion circuit may be reduced without complicating the circuit. This is a new finding obtained by the present inventors from the examples described later. This is a new finding obtained by the present inventors from the examples described later.

A power conversion circuit and a power conversion system according to embodiments of the present disclosure will be more specifically described below with reference to the accompanying drawings. The present disclosure is not limited thereto.

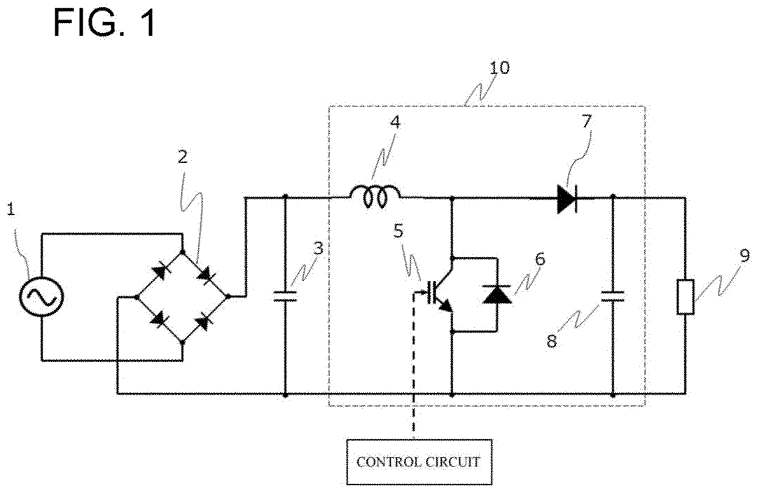

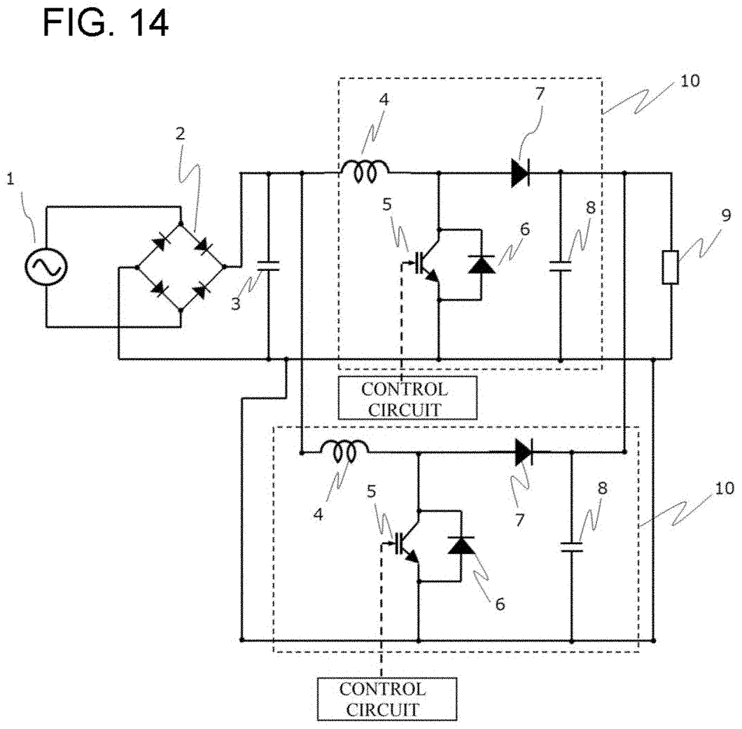

FIG. 1 schematically illustrates a power conversion system including a single-switch power conversion circuit according to a first embodiment of the present disclosure. The power conversion system in FIG. 1 is a power-factor improving system including an AC power supply 1, a diode bridge 2, an input capacitor 3, a reactor 4, a switching element 5, a freewheeling diode 6, a commutating diode 7, an output capacitor 8, and a load 9. The reactor 4, the switching element 5, the freewheeling diode 6, the commutating diode 7, and the output capacitor 8 constitute a power conversion circuit 10 as a power-factor improving circuit. The diode bridge 2 and the input capacitor 3 constitute a full-wave rectifying circuit and rectify a voltage inputted from the AC power supply 1. The reactor 4 is energized during an on period of the switching element 5, the current of the reactor 4 is commutated to the commutating diode 7 during an off period of the switching element 5, and the output capacitor 8 is charged by the sum of the generated voltage and the input voltage of the reactor 4. These operations are periodically repeated to generate a higher voltage than the input voltage. The on/off operations of the switching element 5 are controlled by using a control circuit, so that an alternating voltage waveform and an alternating current waveform are substantially in phase with each other, the power factor is improved, and the improved voltage is supplied to the load 9. It is also preferable to input values measured using various sensors, which are not illustrated, into the control circuit and perform switching control based on the input signals. The power supply 1 is not particularly limited if the power supply 1 is capable of supplying an alternating voltage. The power supply 1 is, for example, a commercial power supply. For example, the power supply 1 may input a direct voltage or an alternating voltage converted from an alternating voltage by using a desired conversion circuit. the power conversion circuit 10 in FIG. 1 may further include a filter or a transformer. Further, in the embodiment of the present disclosure, for example, as shown in FIG. 14, two or more power conversion circuits 10 may be connected in parallel to form an interleave system, which is suitable for a larger current. In the embodiment of the present invention, even when the single-switch power conversion circuits are connected in parallel as shown in FIG. 14, the same effects as in the case of the power conversion circuit shown in FIG. 1 may be obtained.

The commutating diode 7 passes a current in the direction of an electromotive force by a voltage including at least the electromotive force generated from the reactor 4 by energization in an on period of the switching element 5 when the switching element 5 is turned off, and the commutating diode 7 prevents the charge of the output capacitor 8 from flowing backward. In the embodiment of the present disclosure, a gallium oxide-based Schottky barrier diode is used as the commutating diode 7, thereby reducing radiated noise over the power conversion circuit. The reduction of noise leads to a reduction of heat generation over the power conversion circuit as well as a reduction of heat generation in the diodes. Moreover, the reduction of radiated noise over the power conversion circuit enables downsizing of, for example, noise-control components such as a filter and a capacitor, which are not illustrated.

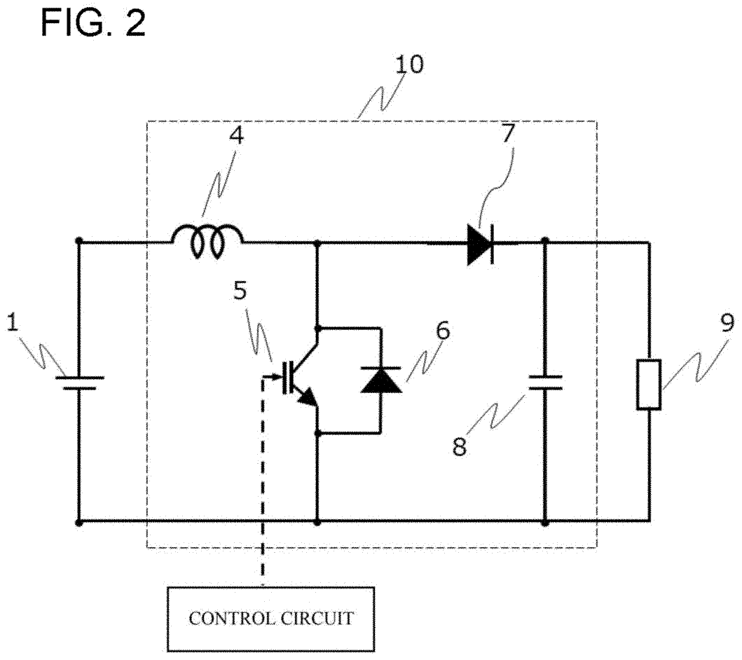

FIG. 2 schematically illustrates a power conversion system including a single-switch power conversion circuit according to a second embodiment of the present disclosure. The power conversion system in FIG. 2 includes a power supply (DC power supply) 1, a reactor 4, a switching element 5, a freewheeling diode 6, a commutating diode 7, and an output capacitor 8. The reactor 4, the switching element 5, the freewheeling diode 6, the commutating diode 7, and the output capacitor 8 constitute a power conversion circuit 10. The reactor 4 is energized during an on period of the switching element 5, the current of the reactor 4 is commutated to the commutating diode 7 during an off period of the switching element 5, and the output capacitor 8 is charged by the sum of the generated voltage and the input voltage of the reactor 4. These operations are periodically repeated to generate a higher voltage than the input voltage, and the voltage is supplied to a load 9. It is also preferable to input values measured using various sensors, which are not illustrated, into a control circuit and perform switching control based on the input signals. The power supply 1 is not particularly limited if the power supply 1 is capable of supplying a direct voltage. The power supply 1 is, for example, a decentralized power supply, a storage battery, or a generator. For example, the power supply 1 may input a direct voltage or a direct voltage converted from an alternating voltage by using a desired conversion circuit. The power conversion circuit 10 in FIG. 2 may further include a transformer.

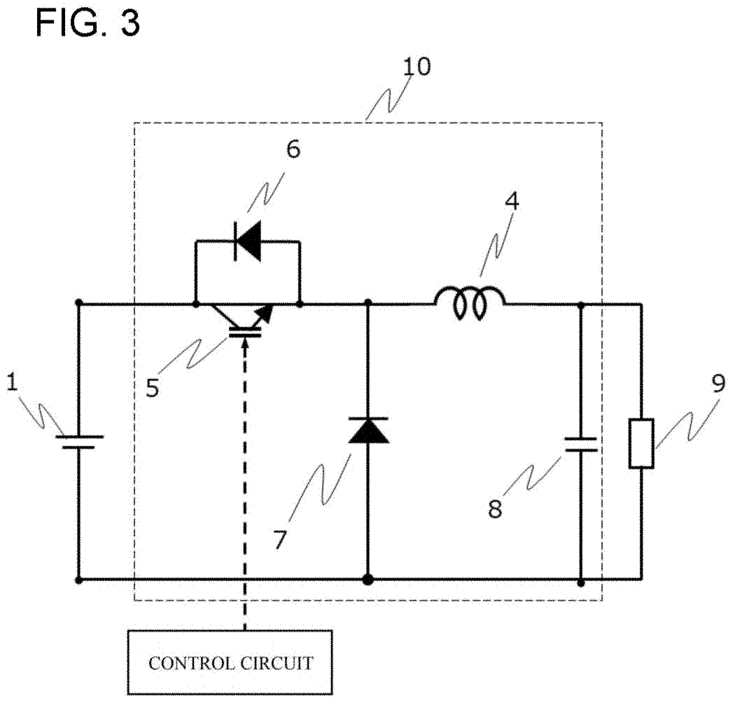

FIG. 3 schematically illustrates a power conversion system including a power conversion circuit according to a third embodiment of the present disclosure. The power conversion system in FIG. 3 includes a power supply (DC power supply) 1, a reactor 4, a switching element 5, a freewheel diode 6, a commutating diode 7, and an output capacitor 8. The reactor 4, the switching element 5, the freewheel diode 6, the commutating diode 7, and the output capacitor 8 constitute a power conversion circuit 10. The reactor 4 is energized during an on period of the switching element 5, the current of the reactor 4 is commutated to the commutating diode 7 during an off period of the switching element 5, and the output capacitor 8 is charged by the generated voltage of the reactor 4. These operations are periodically repeated to generate a lower voltage than the input voltage, and the voltage is supplied to a load 9. It is also preferable to input values measured using various sensors, which are not illustrated, into a control circuit and perform switching control based on the input signals. The power supply 1 is not particularly limited if the power supply 1 is capable of supplying a direct voltage. The power supply 1 is, for example, a decentralized power supply, a storage battery, or a generator. For example, the power supply 1 may input a direct voltage or a direct voltage converted from an alternating voltage by using a desired conversion circuit. The power conversion circuit 10 in FIG. 3 may further include a transformer.

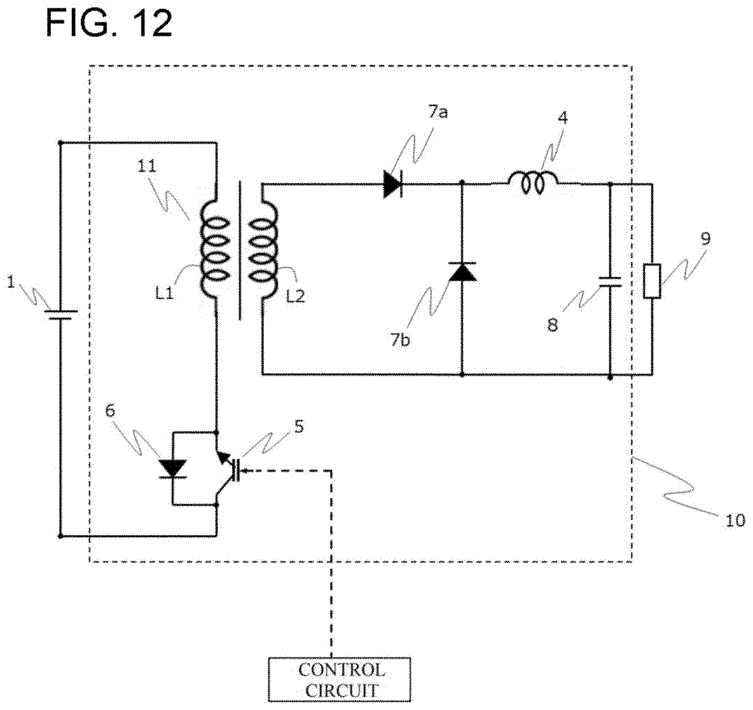

FIG. 12 is a circuit diagram schematically illustrating a single-switch power conversion system according to a forth embodiment of the present disclosure. The power conversion system in FIG. 12 is a power supply (DC power supply) 1, a reactor 4, a switching element 5, a freewheeling diode 6, a commutating diode 7a and 7b, an output capacitor 8, and a transformer 11. The reactor 4, the switching element 5, the freewheeling diode 6, the commutating diode 7a and 7b, the output capacitor 8, and the transformer 11 constitute the power conversion circuit 10. In the forward type power conversion circuit shown in FIG. 12, after the DC power supply 1 is connected to the power conversion circuit 10, when the switching element 5 is turned on and off by the drive pulse from a control circuit, a current to the primary coil (reactor) L1 of the transformer 11 is switched, and a voltage is induced in the secondary coil (reactor) L2. A current generated by this induced voltage is rectified and smoothed by the commutating diode 7a and the reactor (choke coil) 4, and then supplied to a load 9 through a commutating diode 7b. It is also preferable to input actual values measured using various sensors (not illustrated) to the control circuit and perform switching control based on the input signals. The power supply 1 is not particularly limited if the power supply 1 is capable of supplying a direct voltage. The power supply 1 is, for example, a decentralized power supply, a storage battery, or a generator. For example, the power supply 1 may input a direct voltage or a direct voltage converted from an alternating voltage by using a desired conversion circuit. The power conversion circuit 10 in FIG. 12 may further include a transformer.

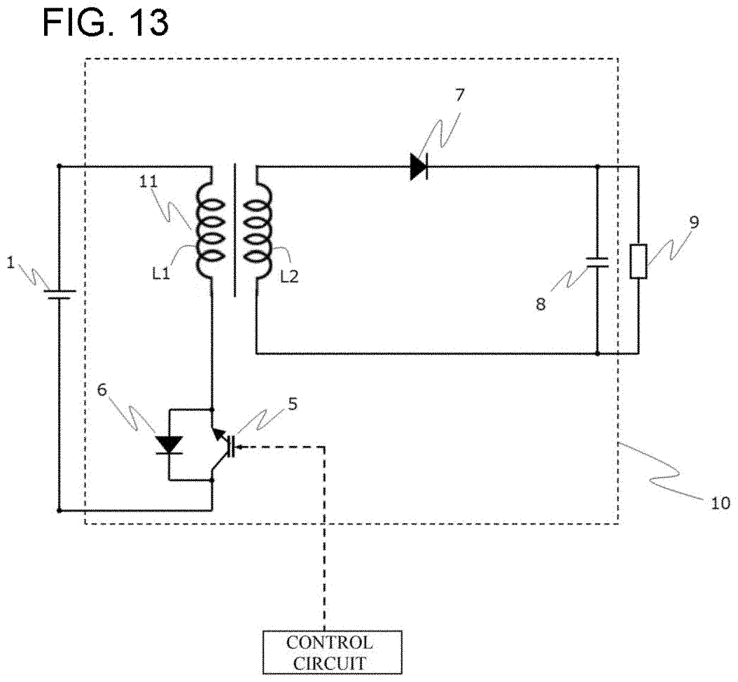

FIG. 13 is a circuit diagram schematically illustrating a single-switch power conversion system according to a fifth embodiment of the present disclosure. The power conversion system in FIG. 13 is a power supply (DC power supply) 1, a switching element 5, a freewheeling diode 6, a commutating diode 7, an output capacitor 8, and a transformer 11. The switching element 5, the freewheeling diode 6, the commutating diode 7, the output capacitor 8, and the transformer 11 constitute the power conversion circuit 10. In the flyback type power conversion circuit shown in FIG. 13, after the DC power supply 1 is connected to the power conversion circuit 10, when the switching element 5 is turned on and off by the driving pulse from a control circuit, and a voltage is induced in the secondary coil, a current to the primary coil of the transformer 11 is switched, a current to the primary coil of the transformer 11 is increased. switched and a voltage is induced in the secondary coil. A current generated by this induced voltage is rectified and smoothed by the commutating diode 7 and the capacitor 8, and then supplied to a load 9. It is also preferable to input actual values measured using various sensors (not illustrated) to the control circuit and perform switching control based on the input signals. The power supply 1 is not particularly limited if the power supply 1 is capable of supplying a direct voltage. The power supply 1 is, for example, a decentralized power supply, a storage battery, or a generator. For example, the power supply 1 may input a direct voltage or a direct voltage converted from an alternating voltage by using a desired conversion circuit. The power conversion circuit 10 in FIG. 13 may further include a transformer.

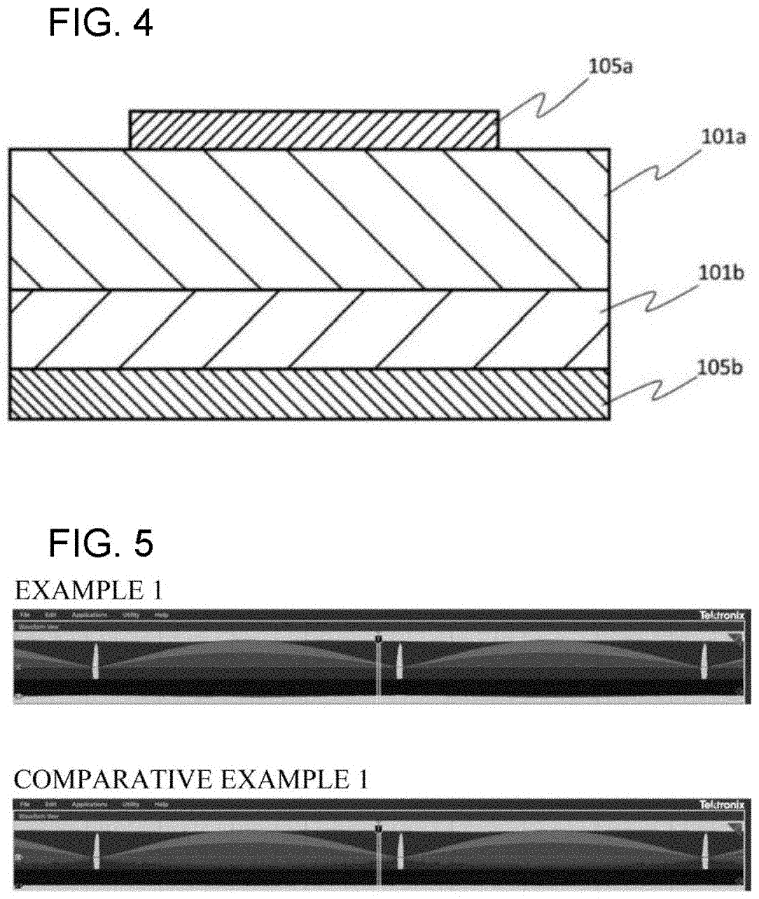

FIG. 4 illustrates an example of the gallium oxide-based Schottky barrier diode (SBD) according to the embodiments of the present disclosure. The SBD in FIG. 4 includes an n− type semiconductor layer 101a, an n+ type semiconductor layer 101b, a Schottky electrode 105a, and an ohmic electrode 105b. In the embodiments of the present disclosure, the n− type semiconductor layer 101a preferably has a carrier concentration of 2.0×10¹⁷/cm³ or less because the effect of reducing radiated noise is more properly obtainable while reducing generated heat over the circuit. The carrier concentration of the n+ type semiconductor layer is not particularly limited but is typically within the range of 1×10¹⁸/cm³ to 1×10²¹/cm³. Furthermore, the thickness of the n+ type semiconductor layer is not particularly limited but is preferably 0.1 μm to 50 μm, more preferably 0.1 μm to 10 μm, and most preferably 0.1 μm to 4 μm in the embodiment of the present disclosure. The n+ type semiconductor layer having the preferable thickness obtains a lower thermal resistance while keeping the switching characteristics.

FIG. 11 illustrates a principal part of the Schottky barrier diode (SBD) as one of the preferred embodiments of the present disclosure. The SBD in FIG. 11 includes an ohmic electrode 202, an n− type semiconductor layer 201a, an n+ type semiconductor layer 201b, Schottky electrodes 203a and 203b, and an insulator film (field insulating film) 204. In this configuration, the insulator film 204 has a cone angle of 10° so as to decrease in thickness toward the inside of a semiconductor device. In FIG. 11, the cone angle of the insulator film 204 is 10° but is not limited thereto. The cone angle may be larger than 10° or smaller than 10°. In the embodiments of the present disclosure, the insulator film 204 preferably has a cone angle of 20° or less. The insulator film 204 is formed on the n− type semiconductor layer 201a and has an opening. In the semiconductor device in FIG. 11, the insulator film 204 is capable of suppressing crystal defects on the end portion, more properly forming a depletion layer, improving field limiting, and more properly suppressing leak current. In the semiconductor device in FIG. 11, the outer end portion of a metallic layer 203b and/or a metallic layer 203c serving as a first electrode layer is placed outside the outer end portion of a metallic layer 203a serving as a second electrode layer, thereby more properly suppressing leak current. Furthermore, the outer end portion of the metallic layer 203b and/or the metallic layer 203c outside the outer end portion of the metallic layer 203a has a tapered region that decreases in thickness toward the outside of the semiconductor device, achieving a configuration with higher pressure tightness. Moreover, in the embodiments of the present disclosure, the n− type semiconductor layer preferably has a guard ring (not illustrated). For example, ion implantation of a p-type dopant (e.g., Mg) on the n− type semiconductor layer allows the provision of the guard ring.

Means of forming the layers in FIG. 11 is not particularly limited and may be any known means unless it interferes with the present disclosure. For example, means of forming films by vacuum deposition, CVD, sputtering, or various coating techniques and then patterning the films by photolithography and means of directly patterning films by a printing technique are available.

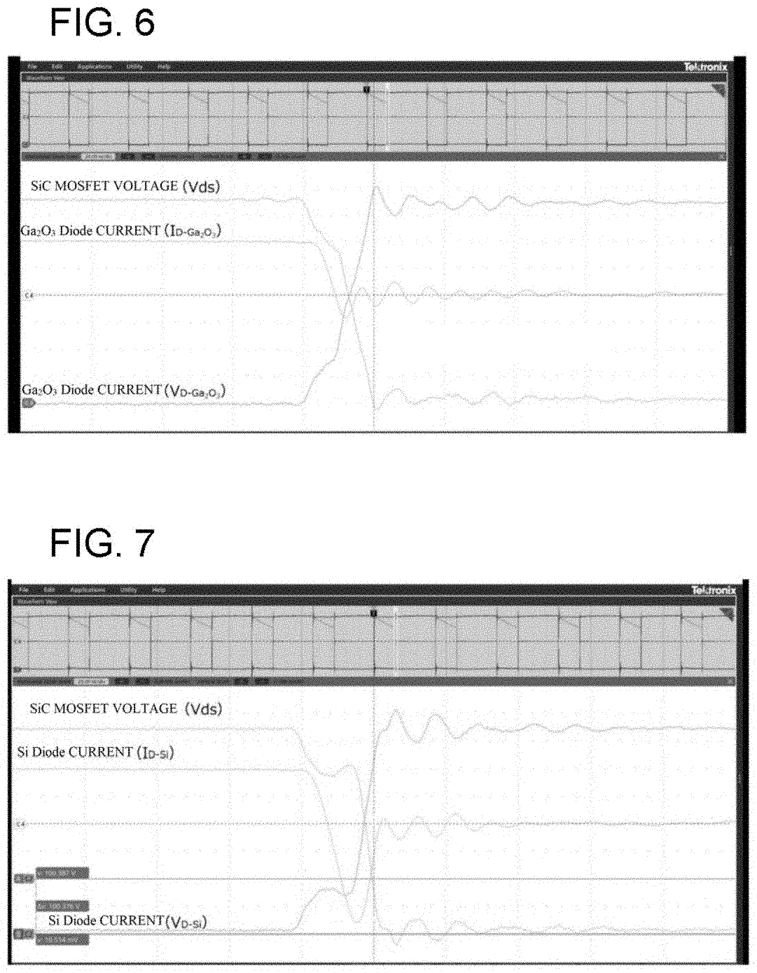

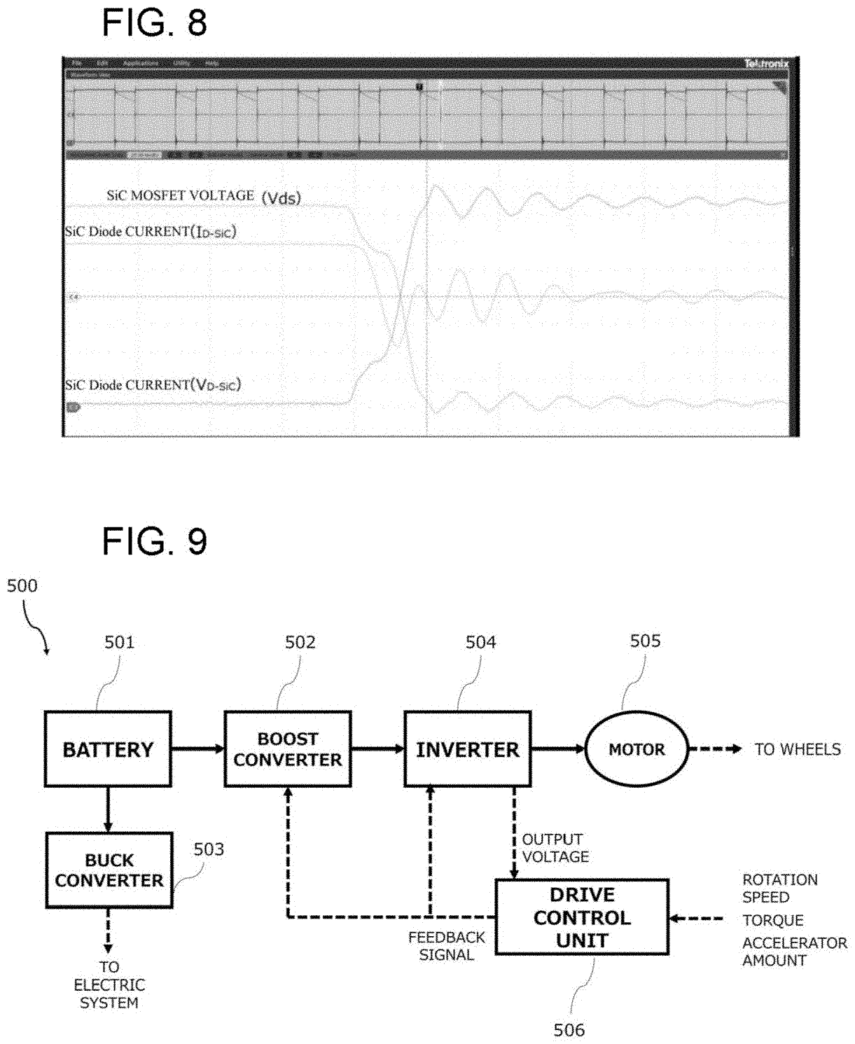

A power-factor improving circuit (PFC circuit) equivalent to the power conversion circuit in FIG. 1 was fabricated and evaluated. A SiC-based MOSFET was used as a switching element. As example 1, a power-factor improving circuit was fabricated with a α-Ga₂O₃-based Schottky barrier diode serving as a commutating diode. As the α-Ga₂O₃-based Schottky barrier diode, an SBD configured as in FIG. 11 was used. As comparative example 1, a power-factor improving circuit was fabricated with a Si-based diode serving as a commutating diode. As comparative example 2, a power-factor improving circuit was fabricated with a SiC-based diode serving as a commutating diode. FIG. 5 shows PFC operation waveforms in example 1 and comparative example 1. Note that the SiC-based MOSFET was switched and controlled by a hard switching method. As is evident from FIG. 5, in the power conversion circuit of comparative example 1, a recovery current waveform is observed on the PFC operation waveform, whereas in the power conversion circuit of example 1, a recovery current waveform is not observed on the PFC operation waveform, noise in the PFC circuit is reduced, and high controllability is obtained. FIGS. 6, 7, and 8 show the diode turn-off waveforms of example 1, comparative example 1, and comparative example 2, respectively. As is evident from FIGS. 6, 7, and 8, in the power conversion circuit of example 1, the total energy of radiated noise is considerably reduced as compared with the power conversion circuits of comparative example 1 and comparative example 2. Specifically, it is understood that a power conversion circuit in which a Schottky barrier diode of gallium oxide is used as a commutating diode is more advantageous in noise characteristics than a power conversion circuit in which a Si-based diode or a SiC-based diode is used as a commutating diode. It was confirmed that noise is reduced in a high-frequency operation at a switching frequency of about 120 kHz in example 1. Moreover, in the power conversion circuit of example 1, heat generation is suppressed also by reducing the total energy of radiated noise. Thus, even if a gallium-oxide-based semiconductor having low thermal conductivity is used, a proper operation is enabled in the power-factor improving circuit.

As is evident from FIGS. 6 to 8, by using a gallium oxide-based Schottky barrier diode for the commutation diode 7 in FIG. 1, the power conversion (hereinafter, it is also called a “control system”.) of example 1 is capable of both reducing the switching loss of the SiC-based MOSFET serving as a switching element and ringing that causes radiation noise. It was also confirmed that the gallium oxide-based Schottky barrier diode obtains excellent switching characteristics particularly when the n− type semiconductor layer has a concentration within the range of 2.0×10¹⁷/cm³ or less and a thickness within the range of 1 μm to 10 μm. Moreover, it was confirmed that better switching characteristics are obtained when a Schottky interface has an electrode area within the range of 0.8 mm² to 1.0 mm² and the n-type semiconductor layer has a concentration within the range of 1.0×10¹⁶/cm³ to 5.0×10¹⁶/cm³ and a thickness within the range of 2 μm to 5 μm. According to such a power conversion circuit according to the embodiment of the present disclosure, as described above, even with a simple single-stone circuit configuration, radiation noise and switching loss of the entire circuit including the switching element as well as the diode can be reduced. Therefore, it is possible to reduce the heat generation of the entire circuit, which in turn makes it possible to reduce the size of the peripheral passive elements.

In order to exhibit the functions described above, the power conversion circuit of the disclosure described above can be applied to a power converter such as an inverter or a converter. FIG. 9 is a block diagram illustrating an exemplary control system applying a semiconductor device according to an embodiment of the disclosure.

As shown in FIG. 9, the control system 500 includes a battery (power supply) 501, a boost converter 502, a buck converter 503, an inverter 504, a motor (driving object) 505, a drive control unit 506, which are mounted on an electric vehicle. The battery 501 consists of, for example, a storage battery such as a nickel hydrogen battery or a lithium-ion battery. The battery 501 can store electric power by charging at the power supply station or regenerating at the time of deceleration, and to output a direct current (DC) voltage required for the operation of the driving system and the electrical system of the electric vehicle. The boost converter 502 is, for example, a voltage converter in which a chopper circuit is mounted, and can step-up DC voltage of, for example, 200V supplied from the battery 501 to, for example, 650V by switching operations of the chopper circuit. The step-up voltage can be supplied to a traveling system such as a motor. The buck converter 503 is also a voltage converter in which a chopper circuit is mounted, and can step-down DC voltage of, for example, 200V supplied from the battery 501 to, for example, about 12V. The step-down voltage can be supplied to an electric system including a power window, a power steering, or an electric device mounted on a vehicle.

The inverter 504 converts the DC voltage supplied from the boost converter 502 into three-phase alternating current (AC) voltage by switching operations, and outputs to the motor 505. The motor 505 is a three-phase AC motor constituting the traveling system of an electric vehicle, and is driven by an AC voltage of the three-phase output from the inverter 504. The rotational driving force is transmitted to the wheels of the electric vehicle via a transmission mechanism (not shown).

On the other hand, actual values such as rotation speed and torque of the wheels, the amount of depression of the accelerator pedal (accelerator amount) are measured from an electric vehicle in cruising by using various sensors (not shown), The signals thus measured are input to the drive control unit 506. The output voltage value of the inverter 504 is also input to the drive control unit 506 at the same time. The drive control unit 506 has a function of a controller including an arithmetic unit such as a CPU (Central Processing Unit) and a data storage unit such as a memory, and generates a control signal using the inputted measurement signal and outputs the control signal as a feedback signal to the inverters 504, thereby controlling the switching operation by the switching elements. The AC voltage supplied to the motor 505 from the inverter 504 is thus corrected instantaneously, and the driving control of the electric vehicle can be executed accurately. Safety and comfortable operation of the electric vehicle is thereby realized. In addition, it is also possible to control the output voltage to the inverter 504 by providing a feedback signal from the drive control unit 506 to the boost converter 502.

As shown in FIGS. 9, a diode and a switching element such as a thyristor, a power transistor, an IGBT, a MOSFET and the like is employed for the switching operation of the boost converter 502, the buck converter 503 and the inverter 504 in the control system 500. The use of gallium oxide (Ga2O3) specifically corundum-type gallium oxide (α-Ga2O3) as its materials for these semiconductor devices greatly improves switching properties. Further, extremely outstanding switching performance can be expected and miniaturization and cost reduction of the control system 500 can be realized by applying a semiconductor film or a semiconductor device of the disclosure. That is, each of the boost converter 502, the buck converter 503 and the inverter 504 can be expected to have the benefit of the disclosure, and the effect and the advantages can be expected in any one or combination of the boost converter 502, the buck converter 503 and the inverter 504, or in any one of the boost converter 502, the buck converter 503 and the inverter 504 together with the drive control unit 506. The control system 500 described above is not only applicable to the control system of an electric vehicle of the semiconductor device of the disclosure, but can be applied to a control system for any applications such as to step-up and step-down the power from a DC power source, or convert the power from a DC to an AC. It is also possible to use a power source such as a solar cell as a battery.

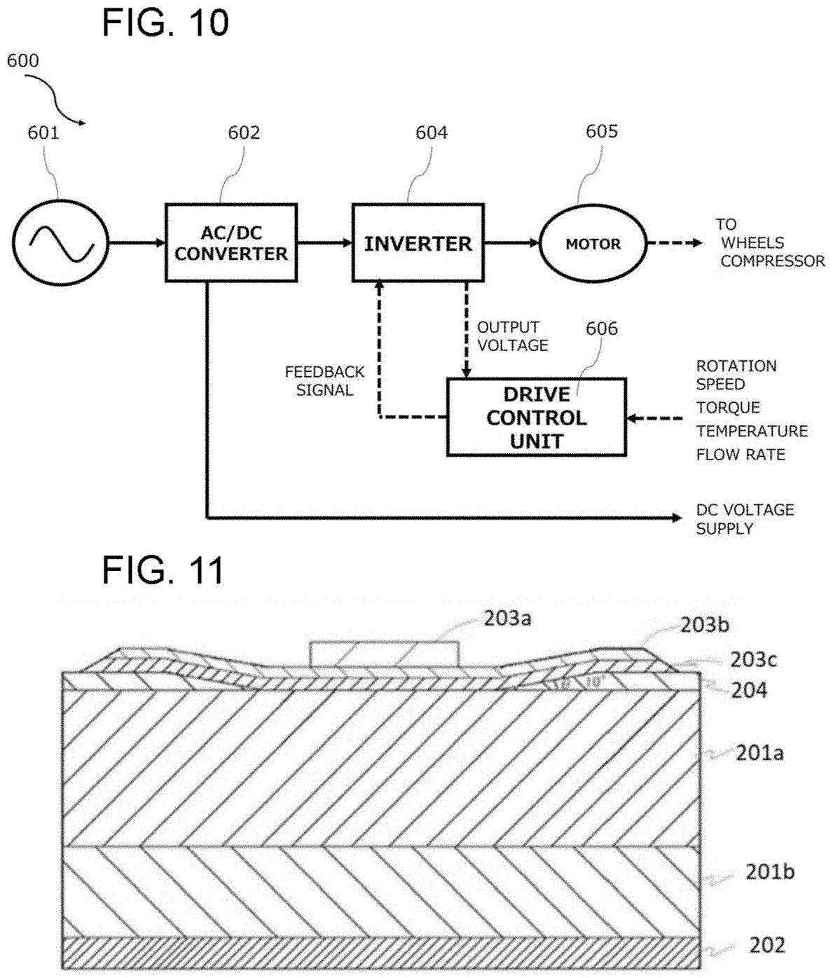

FIG. 10 is a block diagram illustrating another exemplary control system applying a semiconductor device according to an embodiment of the disclosure. The control system is suitable for applying to infrastructure equipment and home appliances or the like operable by the power from the AC power source.

As shown in FIG. 10, the control system 600 is provided for inputting power supplied from an external, such as a three-phase AC power source (power supply) 601, and includes an AC/DC converter 602, an inverter 604, a motor (driving object) 605 and a drive control unit 606 that can be applied to various devices described later. The three-phase AC power supply 601 is, for example, a power plant (such as a thermal, hydraulic, geothermal, or nuclear plant) of an electric power company, whose output is supplied as an AC voltage while being downgraded through substations. Further, the three-phase AC power supply 601 is installed in a building or a neighboring facility in the form of a private power generator or the like for supplying the generated power via a power cable. The AC/DC converter 602 is a voltage converter for converting AC voltage to DC voltage. The AC/DC converter 602 converts AC voltage of 100V or 200V supplied from the three-phase AC power supply 601 to a predetermined DC voltage. Specifically, AC voltage is converted by a transformer to a desired, commonly used voltage such as 3.3V, 5V, or 12V. When the driving object is a motor, conversion to 12V is performed. It is possible to adopt a single-phase AC power supply in place of the three-phase AC power supply. In this case, same system configuration can be realized if an AC/DC converter of the single-phase input is employed.

The inverter 604 converts the DC voltage supplied from the AC/DC converter 602 into three-phase AC voltage by switching operations and outputs to the motor 605. Configuration of the motor 605 is variable depending on the control object. It can be a wheel if the control object is a train, can be a pump and various power source if the control objects a factory equipment, can be a three-phase AC motor for driving a compressor or the like if the control object is a home appliance. The motor 605 is driven to rotate by the three-phase AC voltage output from the inverter 604, and transmits the rotational driving force to the driving object (not shown).

There are many kinds of driving objects such as personal computer, LED lighting equipment, video equipment, audio equipment and the like capable of directly supplying a DC voltage output from the AC/DC inverter 602. In that case the inverter 604 becomes unnecessary in the control system 600, and a DC voltage from the AC/DC inverter 602 is supplied to the driving object directly as shown in FIG. 10. Here, DC voltage of 3.3V is supplied to personal computers and DC voltage of 5V is supplied to the LED lighting device for example.

On the other hand, rotation speed and torque of the driving object, measured values such as the temperature and flow rate of the peripheral environment of the driving object, for example, is measured using various sensors (not shown), these measured signals are input to the drive control unit 606. At the same time, the output voltage value of the inverter 604 is also input to the drive control unit 606. Based on these measured signals, the drive control unit 606 provides a feedback signal to the inverter 604 thereby controls switching operations by the switching element of the inverter 604. The AC voltage supplied to the motor 605 from the inverter 604 is thus corrected instantaneously, and the operation control of the driving object can be executed accurately. Stable operation of the driving object is thereby realized. In addition, when the driving object can be driven by a DC voltage, as described above, feedback control of the AC/DC controller 602 is possible in place of feedback control of the inverter.

In such a control system 600, similarly to the control system 500 shown in FIGS. 9, a diode or a switching element such as a thyristor, a power transistor, an IGBT, a MOSFET or the like is also applied for the purpose of the rectification operation and switching operation of the AC/DC converter 602 and the inverter 604. Switching performance can be improved by the use of gallium oxide (Ga₂O₃), particularly corundum-type gallium oxide (α-Ga₂O₃), as materials for these semiconductor elements. Further, extremely outstanding switching performance can be expected and miniaturization and cost reduction of the control system 600 can be realized by applying a semiconductor film or a semiconductor device of the disclosure. That is, each of the AC/DC converter 602 and the inverter 604 can be expected to have the benefit of the disclosure, and the effects and the advantages of the disclosure can be expected in any one or combination of the AC/DC converter 602 and the inverter 604, or in any of the AC/DC converter 602 and the inverter 604 together with the drive control unit 606.

Although the motor 605 has been exemplified in FIGS. 10, the driving object is not necessarily limited to those that operate mechanically. Many devices that require an AC voltage can be a driving object. It is possible to apply the control system 600 as long as electric power is obtained from AC power source to drive the driving object. The control system 600 can be applied to the driving control of any electric equipment such as infrastructure equipment (electric power facilities such as buildings and factories, telecommunication facilities, traffic control facilities, water and sewage treatment facilities, system equipment, labor-saving equipment, trains and the like) and home appliances (refrigerators, washing machines, personal computers, LED lighting equipment, video equipment, audio equipment and the like).

The embodiments according to the present disclosure are allowed to be combined, some of the constituent elements are surely applicable to other embodiments, some of the constituent elements are allowed to be increased or reduced in number and combined with other known techniques. The configuration is changeable by, for example, a partial omission unless it interferes with the present disclosure. Such a change of the configuration also belongs to the embodiments of the present disclosure.

The power conversion circuit and the control system according to the embodiments of the present disclosure can be used in all fields such as electronic parts, electrical equipment parts, optical or electronic photographic related devices, lighting equipment, power supply devices, automotive electrical equipment, industrial power conditioners, industrial motors, and infrastructure equipment. (e.g. power equipment in buildings and factories, communication equipment, traffic control equipment, water and sewage treatment equipment, system equipment, labor-saving equipment, trains, etc.), home appliances (e.g. refrigerators, washing machines, personal computers, LED lighting equipment, video equipment, audio equipment, etc.).

The embodiments of the present invention are exemplified in all respects, and the scope of the present invention includes all modifications within the meaning and scope equivalent to the scope of claims.

### REFERENCE SIGNS LIST

1 Power supply
2 Diode bridge
3 Input capacitor
4 Reactor
5 Switching element
6 Freewheeling diode
7 Commutating diode
8 Output capacitor
9 Load
10 Power conversion circuit
11 transformer
201a N− type semiconductor layer
201b N+ type semiconductor layer
202 Ohmic electrode
203 Schottky electrode
203a Metallic layer
203b Metallic layer
203c Metallic layer
204 Insulator film
500 control system
501 battery (power supply)
502 boost converter
503 buck converter
504 inverter
505 motor (driving object)
506 drive control unit
507 arithmetic unit
508 storage unit
600 control system
601 three-phase AC power supply
602 AC/DC converter
604 inverter
605 motor (driving object)
606 drive control unit
607 arithmetic unit
608 storage unit
L1 primary coil
L2 secondary coil

1. A power conversion circuit comprising at least:
a switching element; and
a diode, wherein
the power conversion circuit is a single-switch power conversion, and
the diode is a gallium oxide-based Schottky barrier diode.

2. The power conversion circuit according to claim 1, wherein
the switching element is switch-controlled by a hard switching method.

3. The power conversion circuit according to claim 2, wherein
the power conversion circuit further comprises a reactor, and
the switching element opens and closes the inputted voltage via the reactor.

4. The power conversion circuit according to claim 3, wherein the diode is a commutation diode that passes current in a direction of an electromotive force by a voltage including at least the electromotive force generated from the reactor.

5. The power conversion circuit according to claim 3, wherein
the reactor is disposed on an input side than the diode.

6. The power conversion circuit according to claim 4, wherein
the power conversion circuit further comprise an output capacitor;
the power conversion circuit is configured to supply the current to the output capacitor.

7. The power conversion circuit according to claim 1, wherein
the switching element includes a gallium oxide-based MOSFET, a gallium oxide-based IGBT, a gallium nitride-based HEMT, a SiC-based MOSFET, or a SiC-based IGBT.

8. The power conversion circuit according to claim 1, wherein different semiconductors are used for the switching element and the diode.

9. The power conversion circuit according to claim 1, wherein
the semiconductor used for the gallium oxide-based Schottky barrier diode has a larger band gap than a band gap of the semiconductor used for the switching element.

10. The power conversion circuit according to claim 1, wherein
the gallium oxide-based Schottky barrier diode includes at least an n− type semiconductor layer having a carrier concentration of 2.0×10¹⁷/cm³ or less.

11. The power conversion circuit according to claim 10, wherein the n− type semiconductor layer has a thickness of 1 μm to 10 μm.

12. The power conversion circuit according to claim 1, wherein
the power conversion circuit is dc-to-dc conversion circuit.

13. The power conversion circuit according to claim 1, wherein
the power conversion circuit is a step-up conversion circuit.

14. A control system comprising: a power conversion circuit, wherein
the power conversion circuit is the power conversion according to claim 1.
